(19) United States
(12) Patent Application Publication
(10) Pub. No.: US 2023/0335334 A1
(43) Pub. Date: Oct. 19, 2023

(54) GRAIN BOUNDARY DIFFUSION METHOD BASED ON 1:2 PHASE FOR SIMULTANEOUSLY IMPROVED CORROSION RESISTANCE AND COERCIVITY OF MIXED RARE-EARTH PERMANENT MAGNETIC MATERIAL

(71) Applicant: Zhejiang University, Hangzhou (CN)

(72) Inventors: JIAYING JIN, HANGZHOU (CN); MI YAN, HANGZHOU (CN)

(21) Appl. No.: 17/744,656

(22) Filed: May 14, 2022

(30) Foreign Application Priority Data
Apr. 14, 2022 (CN) 2022103921135

(51) Int. Cl. H01F 41/02; B22F 3/24

(52) U.S. Cl. CPC H01F 41/0293; B22F 3/24; B22F 2003/248; B22F 2301/355

(57) ABSTRACT

A grain boundary diffusion method based on 1:2 phase for simultaneously improved corrosion resistance and coercivity of a mixed rare-earth permanent magnetic material is provided. After a Ce-rich mixed rare-earth sintered permanent magnet is prepared using a powder metallurgy process, one of a vapor deposition, an electroplating, a direct physical contact and an adhesive bonding is used to load a grain boundary diffusion alloy source on a surface of the magnet, followed by a grain boundary diffusion heat treatment and a tempering process. The process thereof is simple, and makes full use of the synergistic effect and characteristic diffusion behavior of multiple rare earths in the grain boundary diffusion process to increase the fraction of 1:2 phase in the magnet, and to regulate the composition and distribution of 1:2 phase, thereby simultaneously improving the corrosion resistance and coercivity of the mixed rare-earth permanent magnetic material.

### TECHNICAL FIELD

The present disclosure relates to the field of rare-earth permanent magnetic materials, and in particularly to a grain boundary diffusion method based on 1:2 phase for simultaneously improved corrosion resistance and coercivity of a mixed rare-earth permanent magnetic material.

### DESCRIPTION OF RELATED ART

Cerium (Ce), a high-abundance rare earth element with cheap cost, easily form stable Ce₂Fe₁₄B tetragonal phase, which is prospective to replace those scarce rare earth elements such as neodymium (Nd), praseodymium (Pr), dysprosium (Dy), and terbium (Tb) and to produce low-cost Ce-rich permanent magnets. Based on the continual research progress on the Ce-rich permanent magnets in recent years, the development of mixed rare-earth permanent magnetic materials enriched with Ce, lanthanum (La), or yttrium (Y) can further lower the cost of raw materials, and realize balanced utilization of high-abundance mixed rare-earth resources, being one of the hotspots in current study.

However, intrinsic magnetism of (Ce/La/Y)₂Fe₁₄B are much lower than that of Nd₂Fe₁₄B, thereby decreasing magnetic properties the mixed rare-earth permanent magnetic materials. Particularly for the magnets with high Ce/La/Y substitution, the coercivity is decreased drastically that fails to meet the service requirements. In addition, complex chemical composition, structure and distribution of new grain boundary phase of the mixed rare-earth permanent magnetic materials may exert greater impact on the anti-corrosion properties. For conventional grain boundary reconstruction method or conventional grain boundary diffusion method, more rare-earth-rich grain boundary phases are introduced to isolate short-range exchange coupling between adjacent ferromagnetic main phase grains and to improve the coercivity. However, the introduced rare-earth-rich grain boundary phase acts as corrosion channels to aggravate electrochemical corrosion and deteriorate the corrosion resistance severely. Therefore, how to improve the corrosion resistance and the coercivity simultaneously is a key challenge for batch application of the mixed rare-earth permanent magnetic materials at present.

### SUMMARY

In view of this, in order to solve the problems of simultaneously improved corrosion resistance and coercivity of the mixed rare-earth permanent magnetic material, the present disclosure provides a grain boundary diffusion method based on 1:2 phase, which makes full use of the synergistic effect and characteristic diffusion behavior of multiple rare earths in the grain boundary diffusion process to increase 1:2 phase fraction and regulate the composition and distribution of 1:2 phase.

In order to achieve the above objectives, the present disclosure provides the following technical solutions.

A grain boundary diffusion method based on 1:2 phase for simultaneously improved corrosion resistance and coercivity of a mixed rare-earth permanent magnetic material is provided, which includes following step 1) to step 4):
1) preparing a pristine sintered magnet using a powder metallurgy process;
2) loading a grain boundary diffusion source on a surface of the pristine sintered magnet through one selected from the group consisting of vapor deposition, electroplating, direct physical contact, and adhesive bonding to obtain a loaded magnet;
3) performing grain boundary diffusion heat treatment on the loaded magnet, with a diffusion temperature in a range from 600 degrees Celsius (° C.) to 1000° C. and a diffusion time in a range from 1 hour (h) to 10 h;
4) obtaining the mixed rare-earth permanent magnetic material rich in 1:2 phase, and thereby the corrosion resistance and coercivity thereof are improved simultaneously;
where in step 1), a composition of the pristine sintered magnet is (CeₐNd_{b}RE_{c}RE′_{1-a-b-c})ₓFe_{100-x-y-z}M_{y}B_{z} according to mass percentages, where Ce is cerium; Nd is neodymium; RE is one or more selected from the group consisting of La, Y, gadolinium (Gd) and Pr; RE′ is one or more selected from the group consisting of scandium (Sc) and other lanthanide elements except for Ce, Nd, La, Y, Gd and Pr; Fe is iron; M is one or more selected from the group consisting of aluminum (Al), carbon (C), cobalt (Co), chromium (Cr), copper (Cu), fluorine (F), gallium (Ga), manganese (Mn), molybdenum (Mo), nitrogen (N), niobium (Nb), nickel (Ni), phosphorus (P), plumbum (Pb), sulfur (S), silicon (Si), tantalum (Ta), titanium (Ti), vanadium (V), tungsten (W), zinc (Zn) and zirconium (Zr); B is boron; and a, b, c, x, y and z satisfy the following relationship: 0.3≤a≤0.9, 0≤b≤0.6, 0.1≤c≤0.7, 26≤x≤35, 0.5≤y≤2.5, and 0.75≤z≤1.35;
where in step 2), a composition of the grain boundary diffusion source is R₁₋ᵤ₋ᵥM′ᵤNᵥ according to mass percentages, where R is one or more selected from the group consisting of Nd, Pr, Dy, Tb, holmium (Ho), Gd, Ce, La and Y; M′ is at least one of Fe, Ga, Cu, Co, Ni and Al; N is one or more selected from the group consisting of C, Cr, F, hydrogen (H), Mn, Mo, Nb, Ni, P, Pb, S, Si, Ta, Ti, V, W, Zn and Zr; and u and v satisfy the following relationship: 0<u≤0.9, and 0≤v≤0.1.

The grain boundary diffusion method based on 1:2 phase for simultaneously improved corrosion resistance and coercivity of a mixed rare-earth permanent magnetic material further includes: after performing the grain boundary diffusion heat treatment, performing a tempering process with a tempering temperature in a range from 400° C. to 680° C. and a tempering time in a range from 0 h to 10 h.

The present disclosure may have at least the following beneficial effects compared with related art.

1) The present disclosure applies to a Ce rich mixed rare-earth permanent magnetic material, with Ce accounting for 30% to 90% of the total rare earth, which not only significantly reduces raw material cost of the magnet, but also makes full use of characteristic phase formation law and diffusion behavior of Ce—Fe—B system compared to conventional Nd—Fe—B system to prepare the sintered bulk magnets by a powder metallurgical process. A characteristic REFe₂ phase (1:2 phase) forms in the sintered magnet of the Ce-rich mixed rare-earth in a composition range of the present disclosure, which is different from the conventional-Nd rich phase. The 1:2 phase will be inherited from cast strip into the sintered magnet and will be further evolved to distribute at intergranular regions during the high-temperature sintering and annealing process.

2) Furthermore, the pristine sintered magnet includes at least one of La, Y, Gd, Pr, etc, in addition to Ce and Nd, that is to say, multiple rare earth elements co-exist. The composition design of the mixed rare-earth permanent magnetic materials is concerned with preferential site occupation and phase formation discipline of different rare earth elements, which can fully utilize synergistic effects among multiple rare earth elements and alloying elements as well. As a result, during the grain boundary diffusion, high intrinsic magnetic properties of a main phase can be maintained, meanwhile formation of 1:2 grain boundary phase can be promoted.

3) The grain boundary diffusion source is infiltrated into the pristine sintered magnet, which further promotes precipitation and formation of the 1:2 grain boundary phase in the form of triple junctions and continuous grain boundaries through the elemental diffusion and phase transformation. The spontaneously formed 1:2 phase not only strengthens the chemical stability of the intergranular region, but also improves the wettability to decrease the density of defects at the main phase/grain boundary phase interface. Consequently, the corrosion resistance and coercivity of the mixed rare-earth permanent magnetic material can be simultaneously improved. This is an important reason that the present disclosure can increase the proportion of Ce to the total rare earth up to 90%. The present disclosure not only provides a low-cost preparation method for mixed rare-earth permanent magnetic material, but also solves the key problem of long-standing difficulties in simultaneously improving the corrosion resistance and coercivity of the rare-earth permanent magnetic material. This is of great significance for commercialization and application of high-abundance mixed rare-earth permanent magnetic material, especially in corrosive environments such as marine vessels.

4) Higher fraction of 1:2 grain boundary phase during the grain boundary diffusion is accompanied with tailored composition among main phase grains, the regulated composition and distribution of the 1:2 phase, which is an important way to optimize microstructure of the pristine sintered magnet with different compositions. It also paves a novel way to enhance the coercivity of the mixed rare-earth permanent magnetic material.

5) For the magnet containing high fraction of 1:2 phase after the grain boundary diffusion treatment, a tempering process can be omitted, thereby providing a short-processing method.

### DETAILED DESCRIPTION OF EMBODIMENT

The present disclosure will be further described hereinafter in combination with concrete embodiments, but the present disclosure is not limited to the following embodiments.

### First Embodiment

1) A pristine sintered magnet is prepared using a powder metallurgy process, and a composition of the pristine sintered magnet is: (Ce_{0.4}Nd_{0.38}La_{0.1}Pr_{0.05}Ho_{0.07})_{30.8}Fe_{bal}(Al_{0.35}Ga_{0.15}Cu_{0.25}Nb_{0.25})_{1.5}B_{1.0} according to mass percentages.

2) A grain boundary diffusion source is loaded on a surface of the pristine sintered magnet through adhesive bonding to obtain a loaded magnet, and a composition of the grain boundary diffusion source is (Nd_{0.6}Pr_{0.4})_{0.75}Fe_{0.15}Cu_{0.1} according to mass percentages.

3) Grain boundary diffusion heat treatment is performed on the loaded magnet, with a diffusion temperature of 900° C. and a diffusion time of 5 h, to obtain a treated magnet; and then a tempering process is performed on the treated magnet with a tempering temperature of 480° C. and a tempering time of 3 h.

4) A mixed rare-earth permanent magnetic material rich in 1:2 phase is finally obtained with simultaneously improved corrosion resistance and coercivity. A step-scanned X-Ray Diffraction (XRD) refinement analysis shows that the magnet contains 4.5 wt. % 1:2 phase. A weight loss of the magnet is 2.5 mg/cm³ after exposure in a hot and humid environment (100% relative humidity, 2 bar, 120° C.) for 96 h. An AMT-4 magnetic analysis shows that the coercivity of the magnet is 13.1 kOe.

### First Comparative Example

A difference between the first comparative example and the first embodiment is that the magnet in the first comparative example is not subjected to grain boundary diffusion heat treatment. A step-scanned XRD refinement analysis shows that the untreated magnet contains 2.9 wt. % 1:2 phase, which is smaller than that in the first embodiment. A weight loss of the untreated magnet is 9.4 mg/cm³ after exposure in a hot and humid environment (100% relative humidity for 96 h, 2 bar, 120° C.), which is much greater than that in the first embodiment. An AMT-4 magnetic analysis shows that the coercivity of the untreated magnet is 7.3 kOe, which is much smaller than that in the first embodiment.

### Second Embodiment

1) A pristine sintered magnet is prepared using a powder metallurgy process, and a composition of the pristine sintered magnet is: (Ce_{0.3}Nd_{0.54}Y_{0.1}Gd_{0.06})_{30.5}Fe_{bal}(Co_{0.35}Al_{0.25}Cu_{0.2}Si_{0.05}Zr_{0.15})_{1.3}B_{1.05} according to mass percentages.

2) A grain boundary diffusion source is loaded on a surface of the pristine sintered magnet through direct physical contact to obtain a loaded magnet, and a composition of the grain boundary diffusion source is (Pr_{0.85}La_{0.1}Dy_{0.05})_{0.8}Fe_{0.14}Al_{0.05}H_{0.01} according to mass percentages.

3) Grain boundary diffusion heat treatment is performed on the loaded magnet, with a diffusion temperature of 800° C. and a diffusion time of 6 h, to obtain a treated magnet; and then a tempering process is performed on the treated magnet, with a tempering temperature of 500° C. and a tempering time of 6 h.

4) A mixed rare-earth permanent magnetic material which is rich in 1:2 phase is finally obtained with simultaneously improved corrosion resistance and coercivity. A step-scanned XRD refinement analysis shows that the magnet contains 3.5 wt. % 1:2 phase. A weight loss of the magnet is 2.5 mg/cm³ after exposure in a hot and humid environment (100% relative humidity, 2 bar, 120° C.) for 96 h. An AMT-4 magnetic analysis shows that the coercivity of the magnet is 15.2 kOe.

### Second Comparative Example

A difference between the second comparative example and the second embodiment is that the magnet in the second comparative example is not subjected to grain boundary diffusion heat treatment. A step-scanned XRD refinement analysis shows that the untreated magnet contains 1.8 wt. % 1:2 phase, which is smaller than that in the second embodiment. A weight loss of the untreated magnet is 10.7 mg/cm³ after exposure in a hot and humid environment (100% relative humidity, 2 bar, 120° C.) for 96 h, which is much greater than that in the second embodiment. An AMT-4 magnetic analysis shows that the coercivity of the untreated magnet is 9.8 kOe, which is much smaller than that in the second embodiment.

### Third Embodiment

1) A pristine sintered magnet is prepared using a powder metallurgy process, and a composition of the pristine sintered magnet is: (Ce_{0.55}Nd_{0.35}La_{0.1})_{31.2}Fe_{bal}(Ga_{0.35}Cu_{0.25}Al_{0.2}Zr_{0.15}Nb_{0.05})_{2.0}B_{0.95} according to mass percentages.

2) A grain boundary diffusion source is loaded on a surface of the pristine sintered magnet through magnetron sputtering physical vapor deposition, to obtain a loaded magnet, and a composition of the grain boundary diffusion source is Pr_{0.85}Co_{0.15} according to mass percentages.

3) Grain boundary diffusion heat treatment is performed on the loaded magnet with a diffusion temperature of 850° C. and a diffusion time of 3 h, to obtain a treated magnet.

4) A mixed rare-earth permanent magnetic material which is rich in 1:2 phase is finally obtained with simultaneously improved corrosion resistance and coercivity. A step-scanned XRD refinement analysis shows that the magnet contains 12.5 wt. % 1:2 phase. A weight loss of the magnet is 1.5 mg/cm³ after exposure in a hot and humid environment (100% relative humidity, 2 bar, 120° C.) for 96 h. An AMT-4 magnetic analysis shows that the coercivity of the magnet is 10.2 kOe.

### Third Comparative Example

A difference between the third comparative example and the third embodiment is that the magnet in the third comparative example is not subjected to grain boundary diffusion heat treatment. A step-scanned XRD refinement analysis shows that the untreated magnet contains 8.6 wt. % 1:2 phase, which is smaller than that in the third embodiment. A weight loss of the untreated magnet is 7.2 mg/cm³ after exposure in a hot and humid environment (100% relative humidity, 2 bar, 120° C.) for 96 h, which is much greater than that in the third embodiment. An AMT-4 magnetic analysis shows that the coercivity of the untreated magnet is 6.4 kOe, which is much smaller than that in the third embodiment.

### Fourth Embodiment

1) A pristine sintered magnet is prepared using a powder metallurgy process, and a composition of the pristine sintered magnet is: (Ce_{0.75}Nd_{0.05}Y_{0.1}Gd_{0.1})₃₂Fe_{bal}(Co_{0.5}Si_{0.15}Cu_{0.1}Ga_{0.1}Nb_{0.1}Ta_{0.05})_{2.5}B_{1.05} according to mass percentages.

2) A grain boundary diffusion source is loaded on a surface of the pristine sintered magnet through direct physical contact to obtain a loaded magnet, and a composition of the grain boundary diffusion source is (Pr_{0.8}La_{0.1}Ho_{0.1})_{0.8}Ga_{0.185}H_{0.015} according to mass percentages.

3) Grain boundary diffusion heat treatment is performed on the loaded magnet, with a diffusion temperature of 860° C. and a diffusion time of 5 h, to obtain a treated magnet; and then a tempering process is performed on the treated magnet, with a tempering temperature of 485° C. and a tempering time of 3 h.

4) A mixed rare-earth permanent magnetic material which is rich in 1:2 phase is finally obtained with simultaneously improved corrosion resistance and coercivity. A step-scanned XRD refinement analysis shows that the magnet contains 13.8 wt. % 1:2 phase. A weight loss of the magnet is 1.7 mg/cm³ after exposure in a hot and humid environment (100% relative humidity, 2 bar, 120° C.) for 96 h. An AMT-4 magnetic analysis shows that the coercivity of the magnet is 8.1 kOe.

### Fourth Comparative Example

A difference between the fourth comparative example and the fourth embodiment is that the magnet in the fourth comparative example is not subjected to grain boundary diffusion heat treatment. A step-scanned XRD refinement analysis shows that the untreated magnet contains 10.6 wt. % 1:2 phase, which is smaller than that in the fourth embodiment. A weight loss of the untreated magnet is 12.9 mg/cm³ after exposure in a hot and humid environment (100% relative humidity, 2 bar, 120° C.) for 96 h, which is much greater than that in the fourth embodiment. An AMT-4 magnetic analysis shows that the coercivity of the untreated magnet is 3.5 kOe, which is much smaller than that in the fourth embodiment.

What is claimed is:

1. A grain boundary diffusion method based on 1:2 phase for simultaneously improved corrosion resistance and coercivity of a mixed rare-earth permanent magnetic material, comprising step 1) to step 4):
1) preparing a pristine sintered magnet using a powder metallurgy process;
2) loading a grain boundary diffusion source on a surface of the pristine sintered magnet through one selected from the group consisting of vapor deposition, electroplating, direct physical contact and adhesive bonding to obtain a loaded magnet;
3) performing grain boundary diffusion heat treatment on the loaded magnet, with a diffusion temperature in a range from 600 degrees Celsius (° C.) to 1000° C. and a diffusion time in a range from 1 hour (h) to 10 h;
4) obtaining the mixed rare-earth permanent magnetic material rich in 1:2 phase, and thereby the corrosion resistance and coercivity thereof are improved simultaneously;
wherein in step 1), a composition of the pristine sintered magnet is (CeₐNd_{b}RE_{c}RE′_{1-a-b-c})ₓFe_{100-x-y-z}M_{y}B_{z} according to mass percentages, where Ce is cerium; Nd is neodymium; RE is one or more selected from the group consisting of lanthanum (La), yttrium (Y), gadolinium (Gd) and praseodymium (Pr); RE′ is one or more selected from the group consisting of scandium (Sc) and other lanthanide elements except for Ce, Nd, La, Y, Gd and Pr; Fe is iron; M is one or more selected from the group consisting of aluminum (Al), carbon (C), cobalt (Co), chromium (Cr), copper (Cu), fluorine (F), gallium (Ga), manganese (Mn), molybdenum (Mo), nitrogen (N), niobium (Nb), nickel (Ni), phosphorus (P), plumbum (Pb), sulfur (S), silicon (Si), tantalum (Ta), titanium (Ti), vanadium (V), tungsten (W), zinc (Zn) and zirconium (Zr); B is boron; and a, b, c, x, y and z satisfy the following relationship: 0.3≤a≤0.9, 0≤b≤0.6, 0.1≤c≤0.7, 26≤x≤35, 0.5≤y≤2.5, and 0.75≤z≤1.35;
wherein in step 2), a composition of the grain boundary diffusion source is R₁₋ᵤ₋ᵥM′ᵤNᵥ according to mass percentages, where R is one or more selected from the group consisting of Nd, Pr, dysprosium (Dy), terbium (Tb), holmium (Ho), Gd, Ce, La and Y; M′ is one or more selected from the group consisting of Fe, Ga, Cu, Co, Ni and Al; N is one or more selected from the group consisting of C, Cr, F, hydrogen (H), Mn, Mo, Nb, Ni, P, Pb, S, Si, Ta, Ti, V, W, Zn and Zr; and u and v satisfy the following relationship: 0<u≤0.9, and 0≤v≤0.1.

2. The grain boundary diffusion method based on 1:2 phase for simultaneously improved corrosion resistance and coercivity of a mixed rare-earth permanent magnetic material according to claim 1, further comprising:
after performing the grain boundary diffusion heat treatment, performing a tempering process with a tempering temperature in a range from 400° C. to 680° C. and a tempering time in a range from 0 h to 10 h.
